(19) United States
(12) Patent Application Publication
(10) Pub. No.: US 2018/0314681 A1
(43) Pub. Date: Nov. 1, 2018

(54) GRAPHICAL USER INTERFACE FOR PROJECT BID DOCUMENT CREATION

(71) Applicant: Oldcastle BuildingEnvelope, Inc., Dallas, TX (US)

(72) Inventor: Brad Daron Bentley, Chatfield, MN (US)

(73) Assignee: Oldcastle BuildingEnvelope, Inc., Dallas, TX (US)

(21) Appl. No.: 15/499,024

(22) Filed: Apr. 27, 2017

(51) Int. Cl. G06F 17/24; G06F 3/0482; G06Q 30/06; G06Q 50/08

(52) U.S. Cl. CPC G06F 17/24; G06F 3/0482; G06F 17/30011; G06Q 50/08; G06Q 30/0611

(57) ABSTRACT

Techniques provided herein enable a user (e.g., a construction project bidder) to quickly and easily create a composite document for a construction project bid via a graphical user interface, where the composite document includes the various descriptive documents relating to the construction project. The graphical user interface can pre-populate a hierarchical list of descriptive documents, which the user can manipulate as desired by, for example, changing the order, adding/removing documents, altering hierarchies of documents, etc. Techniques further include creating the composite document for the construction project, based on the list, and providing it to the user.

### BACKGROUND OF THE INVENTION

The process of providing a bid for a construction project can be a complex process. As part of that process, a bidder may need to not only to determine the overall cost of the construction project, but also gather information regarding the materials to be used in the construction project to provide to their customer. This information can include various types of descriptive documents (or “artifacts”), including marketing sell sheets, installation instructions, test reports, warranty, and other technical references.

Because this information can include many independent descriptive documents, gathering these materials can be arduous. Even when the descriptive documents are available from a single document database (e.g., maintained by a distributor or manufacturer), the bidder often must still locate, transfer, and store those descriptive documents as independent files or a compressed folder, then provide the descriptive documents to the customer in a presentable manner. But these descriptive documents are rarely obtained in order, and everything is stored at a single level (without any hierarchy). Moreover, the various descriptive documents may have wildly different appearance, branding, and legal information based solely on the time they were generated, thereby making the materials seem disorganized.

### BRIEF SUMMARY OF THE INVENTION

Techniques provided herein enable a user (e.g., a construction project bidder) to quickly and easily create a composite document for a construction project bid via a graphical user interface, where the composite document includes the various descriptive documents relating to the construction project. The graphical user interface can pre-populate a hierarchical list of descriptive documents, which the user can manipulate as desired by, for example, changing the order, adding/removing documents, altering hierarchies of documents, etc. Techniques further include creating the composite document for the construction project, based on the list, and providing it to the user.

An example method of enabling creation of documentation relating to a construction project, according to the disclosure, includes providing, in a graphical user interface, a list of documents having a plurality of hierarchical levels and a plurality of document entries. The list of documents provides, for each document entry in the plurality of document entries an identity of a respective document, and an indication of a hierarchy attributed to the respective document. The method further includes enabling a user to manipulate the list of documents via the graphical user interface, subsequent to enabling the user to manipulate the list of documents, receiving a request to create a composite document, and in response to receiving the request, creating the composite document. The composite document comprises documents corresponding to the plurality of document entries of the list of documents, and an order and hierarchy of the plurality of document entries of the list of documents provided in the graphical user interface corresponds to an order and hierarchy of respective documents in the composite document.

In some embodiments, the method can include one or more of the following features. The method can further comprise providing the composite document to the user. Enabling the user to manipulate the list of documents can comprise enabling the user to, for at least one document entry of the plurality of document entries, alter the hierarchy attributed to the respective document. Enabling the user to manipulate the list of documents can comprise enabling the user to alter the order of the plurality of document entries of the list of documents, thereby altering the order of the respective documents in the composite document. The method can further comprise obtaining information regarding the construction project and initially populating the list of documents based on the obtained information regarding the construction project. Creating the composite document can comprise creating a table of contents of the composite document, the table of contents showing the hierarchy attributed to each document in the composite document. The method can further comprise enabling the user to, via the graphical user interface search for an additional document and add an additional document entry, corresponding to the additional document, to the list of documents. Enabling the user to search for the additional document comprises accessing a database of available documents. The method can further comprise enabling the user to, via the graphical user interface, upload a document to include in the composite document. Creating the composite document can further comprise including, on at least one page of the composite document, an original page of a document in the composite document and at least one additional feature. The at least one additional feature can comprise a page number of the composite document.

An example server, according to the disclosure, comprises a communication interface, a memory, and a processing unit communicatively coupled with the memory and the communication interface. The processor is configured to cause a graphical user interface to provide a list of documents having a plurality of hierarchical levels and a plurality of document entries, where the list of documents provides, for each document entry in the plurality of document entries an identity of a respective document, and an indication of a hierarchy attributed to the respective document. The processor is also configured to enable a user to manipulate the list of documents via the graphical user interface, and subsequent to enabling the user to manipulate the list of documents, receiving a request to create a composite document. The processor is further configured to, in response to receiving the request, create the composite document, where the composite document comprises documents corresponding to the plurality of document entries of the list of documents, and an order and hierarchy of the plurality of document entries of the list of documents provided in the graphical user interface corresponds to an order and hierarchy of respective documents in the composite document.

The server can include one or more of the following features. The processing unit may be further configured to provide the composite document to the user via the communication interface. The processing unit may be configured enable the user to manipulate the list of documents by enabling the user to, for at least one document entry of the plurality of document entries, alter the hierarchy attributed to the respective document. The processing unit may be configured to enable the user to manipulate the list of documents by enabling the user to alter the order of the plurality of document entries of the list of documents, thereby altering the order of the respective documents in the composite document. The processing unit may be further configured to obtain information regarding the construction project and initially populate the list of documents based on the obtained information regarding the construction project. The processing unit may be further configured to enable the user to, via the graphical user interface search for an additional document and add an additional document entry, corresponding to the additional document, to the list of documents.

An example non-transitory computer-readable medium, according to the disclosure, has instructions embedded thereon for enabling creation of documentation relating to a construction project. The instructions include computer code for providing, in a graphical user interface, a list of documents having a plurality of hierarchical levels and a plurality of document entries, where the list of documents provides, for each document entry in the plurality of document entries an identity of a respective document, and an indication of a hierarchy attributed to the respective document. The instructions further include computer code for enabling a user to manipulate the list of documents via the graphical user interface and, subsequent to enabling the user to manipulate the list of documents, receiving a request to create a composite document. The instructions include computer code for, in response to receiving the request, creating the composite document, where the composite document comprises documents corresponding to the plurality of document entries of the list of documents, and an order and hierarchy of the plurality of document entries of the list of documents provided in the graphical user interface corresponds to an order and hierarchy of respective documents in the composite document.

The non-transitory computer-readable medium can include one or more of the following features. The instructions may further include computer code for providing the composite document to the user. The computer code for enabling the user to manipulate the list of documents may comprise computer code for enabling the user to, for at least one document entry of the plurality of document entries, alter the hierarchy attributed to the respective document.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a simplified block diagram of a document creation system, according to an embodiment, that can be utilized in the techniques described herein for project bid document creation.

FIGS. 2-3C are screen captures illustrating various screens of a graphical user interface for construction project bid document creation, according to an embodiment.

FIGS. 4A-4C are screen captures of a document viewer application showing pages from a composite document, according to an embodiment.

FIG. 5 is a flow diagram of a method of enabling creation of documentation relating to a construction project, according to an embodiment.

FIG. 6 illustrates an embodiment of a computer system, according to an embodiment.

### DETAILED DESCRIPTION OF THE INVENTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

It can be noted that, as referred to herein, the terms “document,” “documentation,” and variations thereof can include electronic (soft copy) documents, physical (hard copy) documents and/or other electronic and/or physical materials.

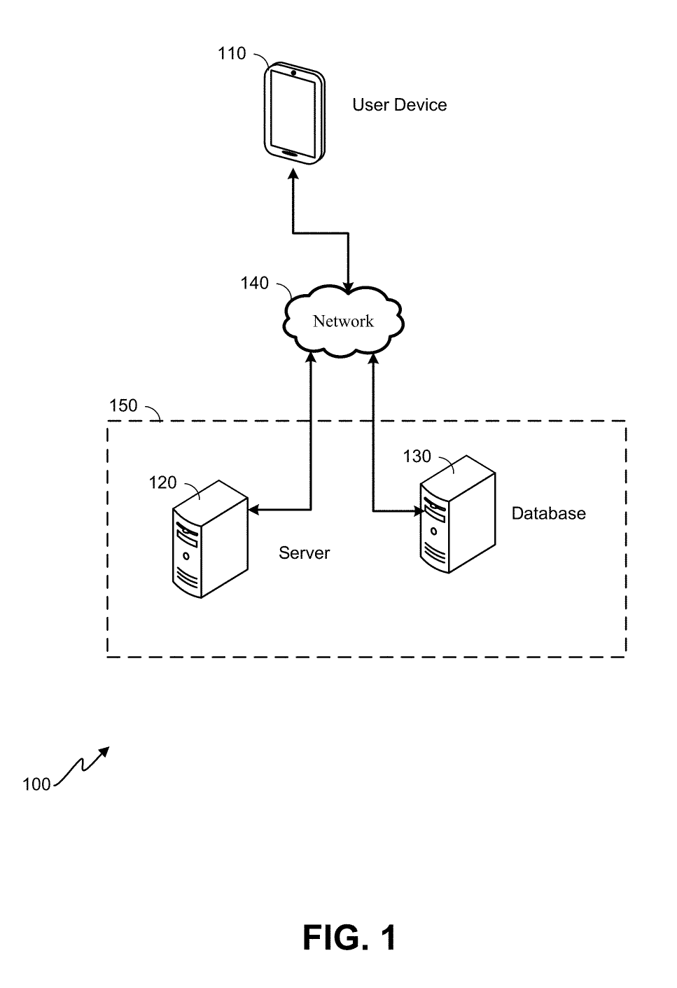

FIG. 1 is a simplified block diagram of an embodiment of a document creation system 100 that can be utilized in the techniques described herein for project bid document creation. As with other figures provided herein, FIG. 1 is provided as a non-limiting example. The components and/or architecture of other embodiments may vary, depending on desired functionality. Here, the document creation system 100 comprises a user device 110, a server 120, a database 130, and a network 140. In some embodiments, the server 120 and the database 130 may be maintained by a materials provider 150, such as a manufacturer or distributor. For simplicity, only one of each component type is illustrated in FIG. 1. In practice, however, embodiments may include multiple servers 120, databases 130, networks 140, materials providers 150, and/or user devices 110. Additionally, the various components may be distributed among various geographical locations, including the server 120 and database 130. That is, although some embodiments may enable a single materials provider 150 to maintain the server 120 and database 130, these components may not necessarily be disposed in the same geographical location.

Lines in the figure represent data communication links between the various components of the document creation system 100. Communication may be carried out in any of a variety of ways, depending on desired functionality, the indication technology utilized, and/or other factors. The network 140 may comprise one or more data communication networks including public and/or private networks, including the Internet. Data may be communicated via wired and/or wireless communication technology, in accordance with applicable protocols and/or standards.

As previously discussed, a user may desire to provide a bid for a construction project to a customer. As part of this process, the user (also referred to herein as “the bidder”) may contact the materials provider 150 of materials used in the construction project to determine the cost of the materials and/or to gather descriptive documents, or “artifacts,” regarding the materials to pass along to the user's customer (e.g., the entity for whom the user is providing the bid). The user may do so, for example, via the user device 110. Although illustrated as a mobile phone, the user device 110 may comprise any of a variety of devices, including a mobile device, tablet, laptop, personal computer, or the like.

According to techniques provided herein, the materials provider 150 may provide a server 120 and database 130 with which the user may create a composite document for the project bid containing all of the descriptive documents in an orderly and professional format. For example, using an application executed on the user device 110 and/or a web browser, the user device 110 can access the server 120, to provide the user with a graphical user interface (shown on a display of the user device 110) with which the user may interact to create the composite document (e.g., via a web portal). This graphical user interface can enable the user to select descriptive documents to include in the composite document and alter their order and/or hierarchy so that the composite document provides the descriptive documents contained therein in a logical format. These descriptive documents may be stored in the database 130. Once the formatting (e.g., content, order, and/or hierarchy) of the descriptive documents is completed, the user can then cause the server 120 to create the composite document by extracting the corresponding descriptive documents from the database 130 and compiling the composite document accordingly.

The composite document may then be provided to the user in any of a variety of ways, depending on desired functionality. For example, the composite document may be downloaded to the user device 110 automatically via an application executed by the user device 110. Additionally or alternatively, the composite document may be stored at the server 120 or other location accessible via the network 140, and a uniform resource locator (URL) may be provided to the user device 110. The composite document and/or corresponding URL may additionally or alternatively be sent to the user via other means, such as by email.

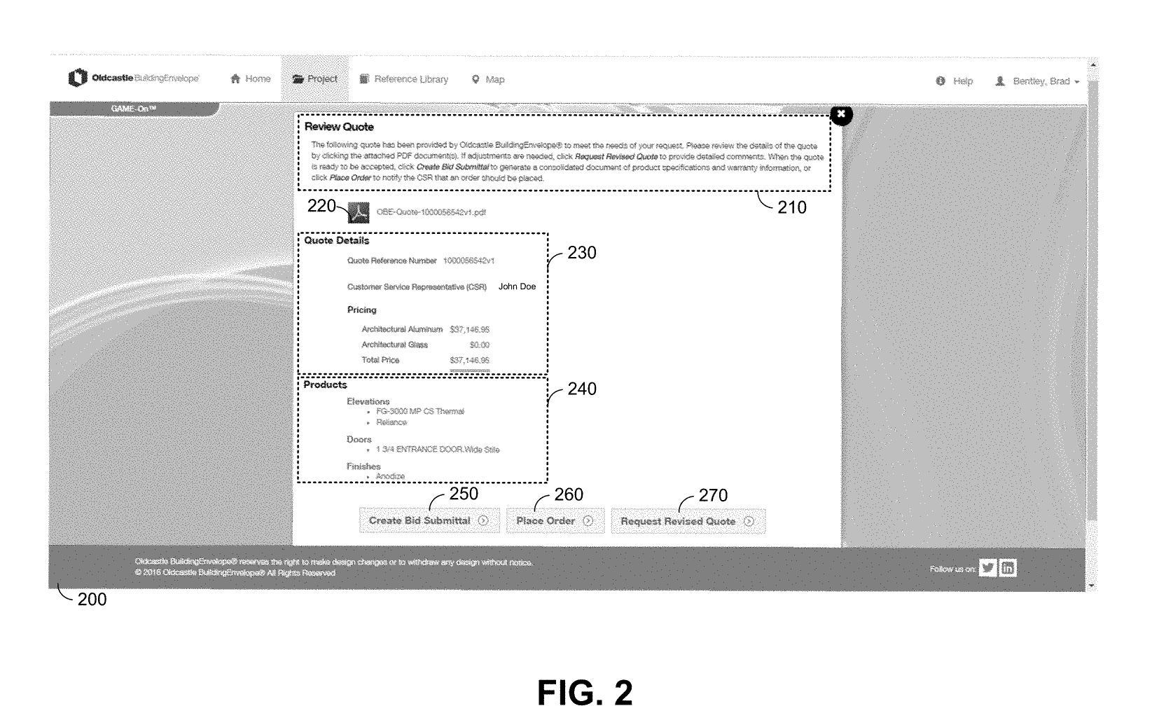

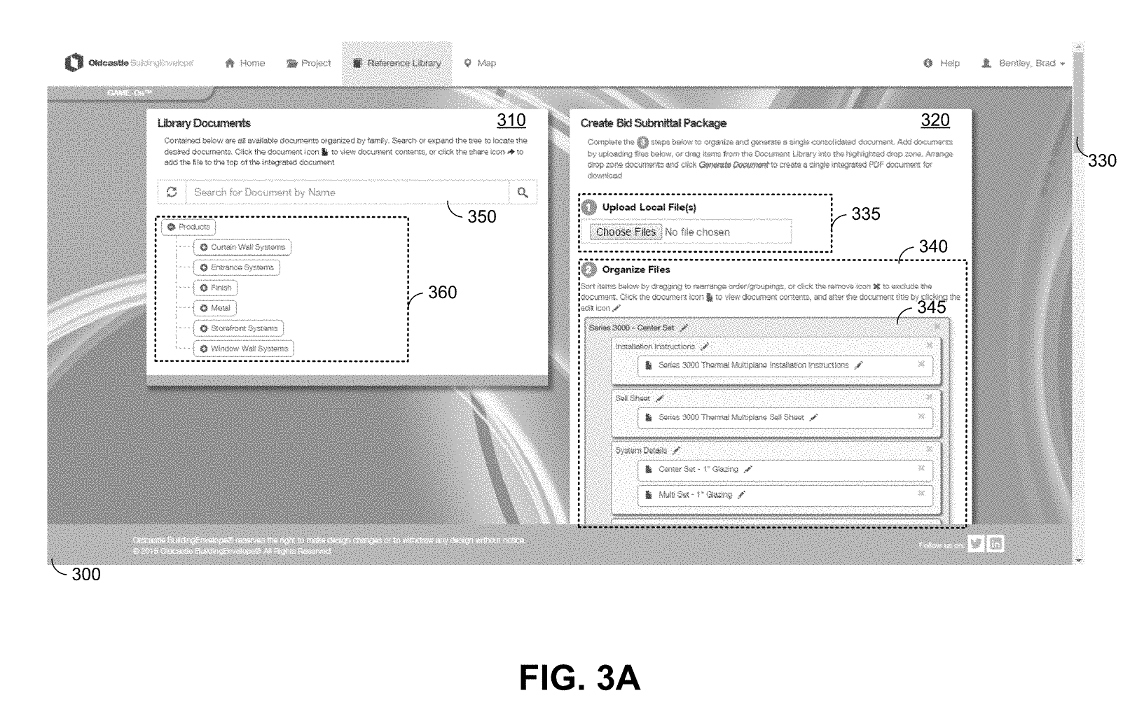

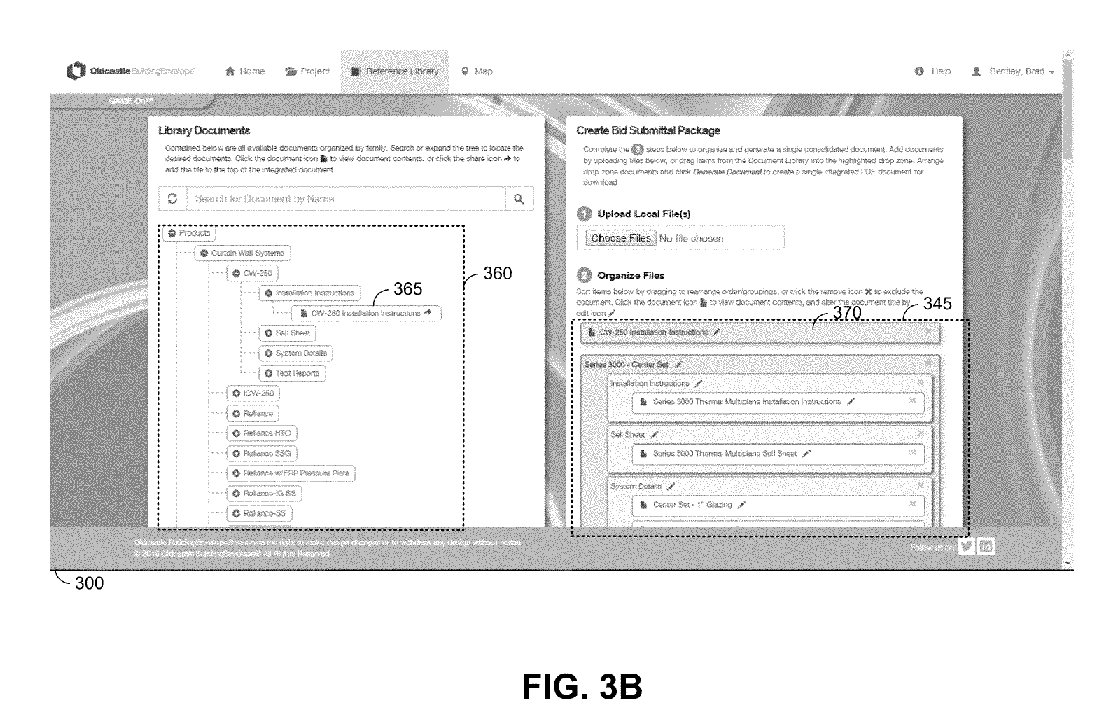

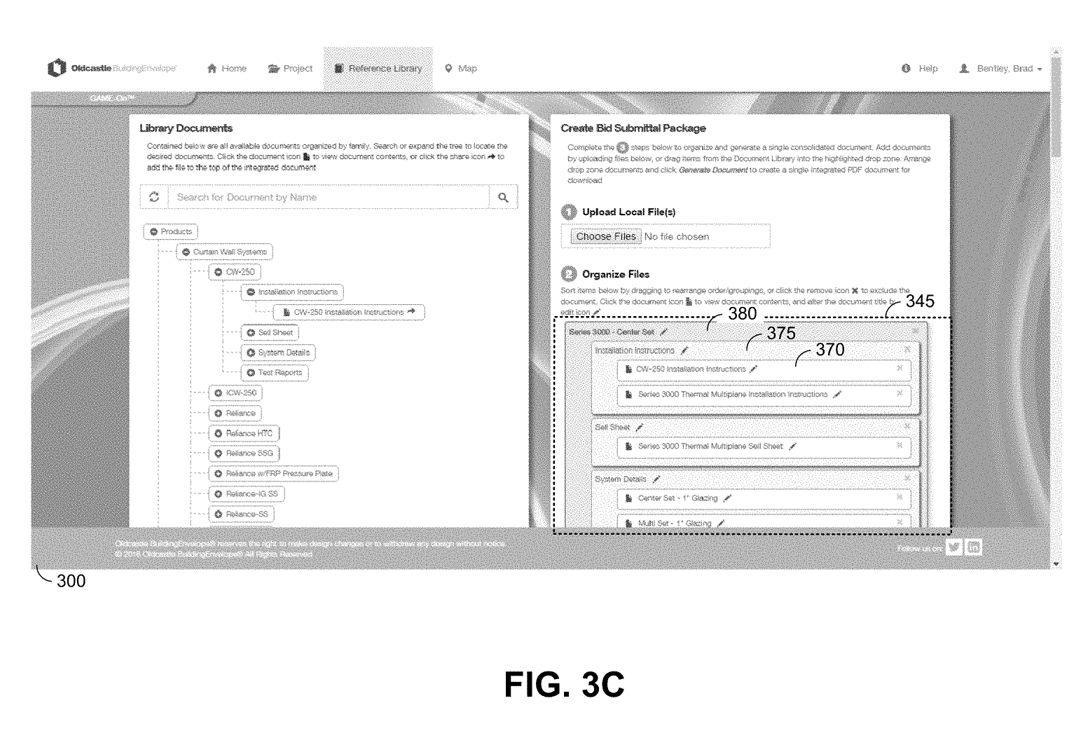

FIGS. 2-3C are screen captures illustrating various screens of a graphical user interface for construction project bid document creation, according to an embodiment. It can be noted that the screenshots provided herein are representative of a particular implementation by Oldcastle BuildingEnvelope®, with specific pricing, product, and other details. However it will be understood by a person of ordinary skill in the art that these details may be dependent on the scenario, and the graphical user interface itself may differ from that shown, depending on desired functionality. According to some embodiments, the graphical user interface may implement a “responsive design,” in which the look of the graphical user interface may change to accommodate different contexts (e.g., different browsers, applications, user device types, etc.). As previously noted, the graphical user interface may be displayed on a user device 110 and hosted by a server 120 of the materials provider 150. The way in which the user interacts with the graphical user interface can vary depending on the type of user device 110 used. (E.g., a user may interact with the graphical user interface by touching a touchscreen display, using a mouse and/or keyboard, etc.)

In some embodiments, the graphical user interface illustrated in FIGS. 2-3C may be accessed by providing a user information, such as a user ID and password. As such, user-specific information may be stored by the materials provider 150 (e.g., and the database 130). Additionally or alternatively, information regarding an entity (such as a company) to which the user belongs to be associated with the user, enabling customization of the construction project quote based on the user and/or entity.

FIG. 2 is a screen capture illustrating a screen 200 of a graphical user interface that enables reviewing quote information regarding the construction project bid. (It can be noted that the dotted lines in FIG. 2 are illustrated to reference to various portions of the screen 200, and may not be displayed in the screen 200.) Here, the screen 200 includes a page description 210, document link 220, quote details 230, product listing 240, and various interactive buttons 250, 260, 270. Other elements are illustrated in the screen 200 (shown at the top and bottom of the screen 200) are related to other functions available to the user in this particular implementation, and they may vary depending on desired functionality.

The screen 200 may be related to a new or existing construction project created by the user (as illustrated in the “Project” folder at the top of the screen 200). Here, the user may have already submitted a request to the materials provider 150 for a quote for the materials related to the construction project, and the details of that quote are made accessible via this screen 200 of the graphical user interface. (The request for the quote may have been made via another screen of the graphical user interface, telephone, email, etc.) The page description 210 can provide a description of the functionality of this particular screen in the graphical user interface.

The screen 200 also provides a summary of the quote information provided by the materials provider 150. Among other things, the screen 200 includes a document link 220, which, if selected, can retrieve the detailed quote document. Quote details 230 are also provided, including reference number, the name of a Customer Service Representative (CSR) (e.g., a representative of the materials provider 150 providing the quote), and pricing summary. The product listing 240 can include a listing of the products related to the construction project bid, which may have been selected by the user.

In this embodiment, the user may proceed by selecting one of the interactive buttons 250, 260, 270 near the bottom of the screen 200. The Place Order button 260 allows the user to purchase the products included in the quote (shown in the product listing 240). The Request Revised Quote button 270 allows the user to alter the types and/or quantity of products used for the quote, and the Create Bid Submittal button 250 allows the user to precede to the bid submittal package creation screen illustrated in FIGS. 3A-3C. (FIGS. 3A, 3B, and 3C illustrate initial, subsequent, and final configurations of the bid submittal package creation screen 300, respectively.)

FIG. 3A is a screen capture illustrating an initial configuration of the of the bid submittal package creation screen 300. The bid submittal package creation screen 300 enables the user to create the consolidated document (or “bid submittal package”) for the construction project bid, comprising descriptive documents for each of the products related to the construction project bid (e.g., as listed in the screen 200 of FIG. 2). In the embodiment illustrated in FIGS. 3A-3C, the bid submittal package creation screen 300 includes a Library Documents pane 310 and a Bid Submittal Package pane 320. (It can be noted that, due to display limits on the user device 110, the Bid Submittal Package pane 320 is truncated at the bottom of the bid submittal package creation screen 300. However, the scroll bar 330 enables the user to scroll down to view the rest of the Bid Submittal Package pane 320.)

The Bid Submittal Package pane 320 includes an upload file portion 335 and an organize files portion 340. In the organize files portion 340, the document list 345 is provided, having entries corresponding to documents to be included in the consolidated document. The document list 345 is shown in a hierarchical manner, illustrating how descriptive documents may be grouped into different hierarchies.

The graphical user interface allows the user to customize the consolidated document to be created by manipulating the document list 345. For example, a user may be able to edit the names of the descriptive documents and/or titles of the different hierarchies by selecting the “pencil” icon next to the name and/or title. The user may also be able to rearrange the descriptive documents in different order, and/or hierarchies or groupings. (This can be achieved, for example, using a mouse to drag and drop the entry in the document list 345 corresponding to the descriptive document into a desired place within the document list 345.) Descriptive documents and/or hierarchies may be removed from the list by, for example, selecting the “X” in the upper-right-hand corner of the entry in the document list 345 corresponding to the descriptive document and/or hierarchies.

Adding descriptive documents to the document list 345 can be done in any of several ways. According to some embodiments, the document list 345 may be pre-populated with documents regarding the products related to the construction project bid (e.g., the products in the product list 240 of FIG. 2). According to some embodiments, the descriptive documents (which may be part of a documents library stored in a database 130) may be selected by the server 120 to be over inclusive, thereby increasing the likelihood that the list will include all documents desired by the user and allowing the user to simply delete any unwanted documents from the list. The user may also manually upload a descriptive document using the upload file portion 335 of the bid submittal package creation screen 300 to choose a file (e.g., stored on and/or otherwise accessible via the user device 110). Additionally or alternatively, the Library Documents pane 310 allows the user to search the document library stored in the database 130 by entering a keyword (e.g., document name, description, etc.) into a search field 350 and/or by browsing a document tree 360. Once a desired document is located in the Library Documents pane 310, it can be added to the document list 345 (e.g., by the user dragging and/dropping a graphical representation corresponding to the desired document into the desired place in the document list 345).

FIG. 3B is a screen capture illustrating an subsequent configuration of the of the bid submittal package creation screen 300, illustrating a way in which a document from the document tree 360 is added to the document list 345. Here, the user browses the document tree 360, which lists documents in the document library in a hierarchical manner, by selecting topics and subtopics related to the desired document until the desired document 365 (or, more precisely, a graphical representation of the desired document) is found. Here, the desired document is entitled “CW-250 Installation Instructions.”

As previously noted, the user can add the desired document 365 to the document list 345 in any of a variety of ways, depending on desired functionality. In this example, the user may drag and drop the desired document 365 into the document list 345, or simply select the arrow icon at the right-hand side of the desired document 365. Once added to the document list 345, the resulting entry 370 can then be placed in a desired order and/or hierarchical level within the document list 345.

FIG. 3C is a screen capture illustrating an final configuration of the of the bid submittal package creation screen 300, illustrating how the resulting entry 370 can be placed within the document list 345. Here, the user has selected the resulting entry 370 and placed it at a desired place within the document list 345 (e.g., by dragging/dropping the resulting entry, using arrow keys on a keyboard of the user device 110, etc.) The final location of the resulting entry 370 is under two additional hierarchical levels: “Installation Instructions” 375 and “Series 300—Center Set” 380.

Once the order and hierarchy of the entries in the document list 345 correspond to the order and hierarchy desired in the composite document, the user can cause the document creation system 100 to create the corresponding composite document by providing a input. (In the illustrated embodiment, a Create Document button is visible when the user scrolls down on the bid submittal package creation screen 300.) In response, the server 120 can obtain documents corresponding to the documents in the document list 345 from the database 130 and create the composite document.

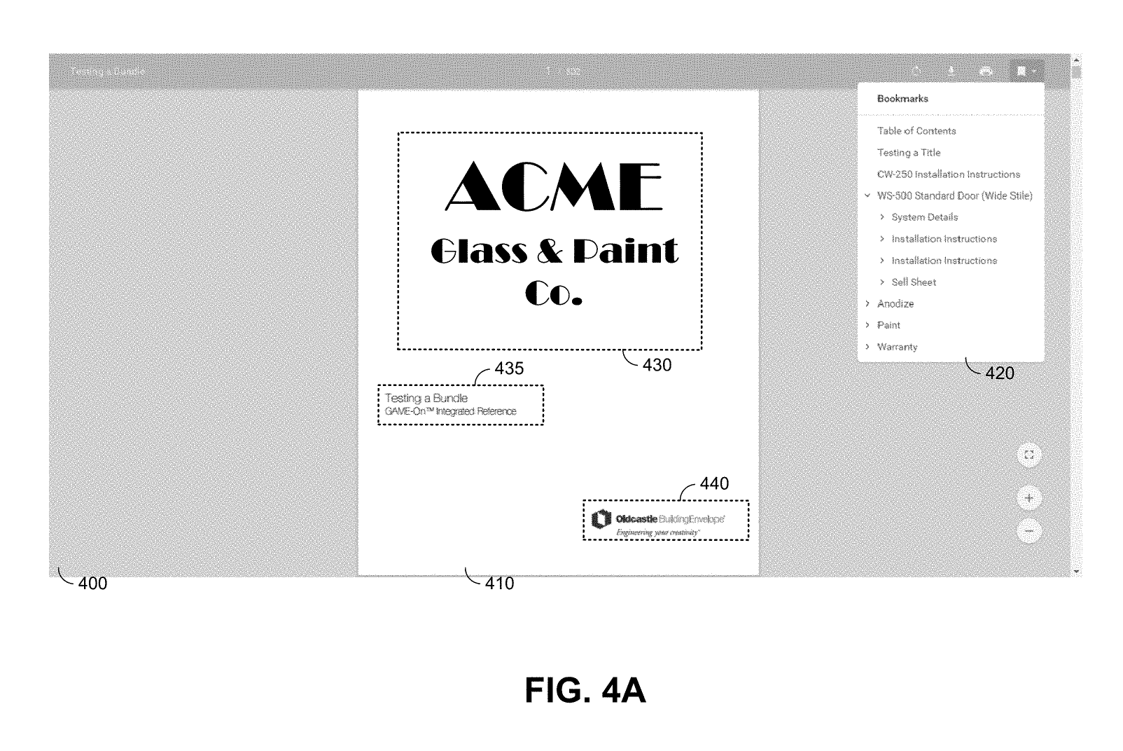

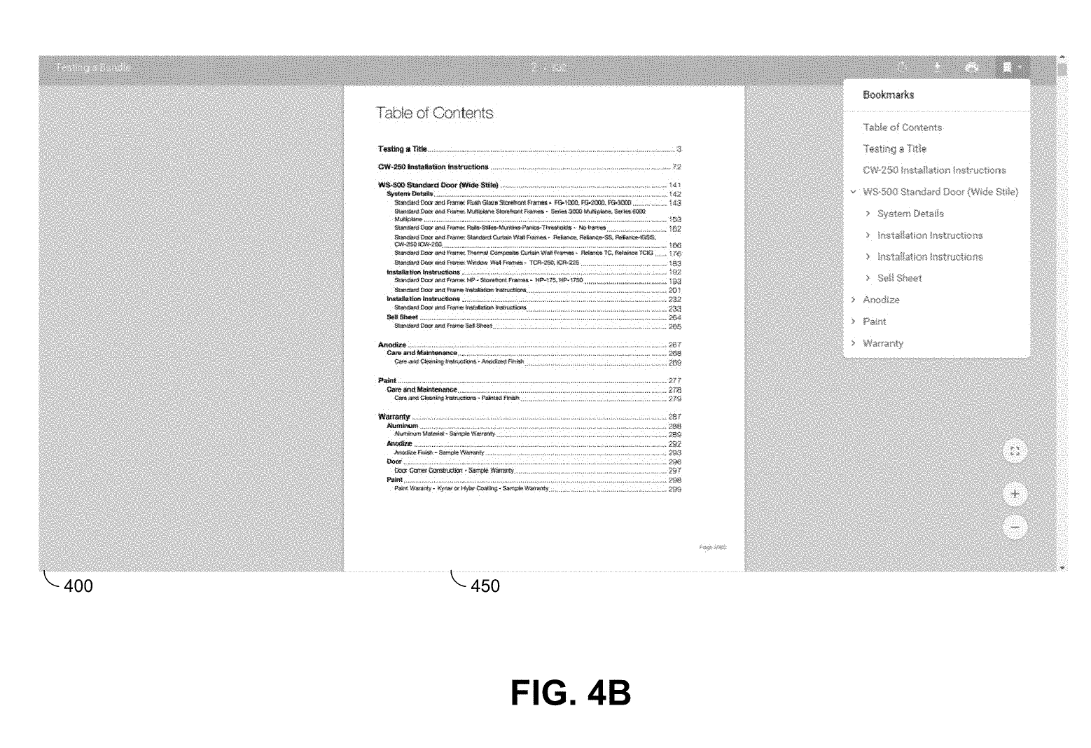

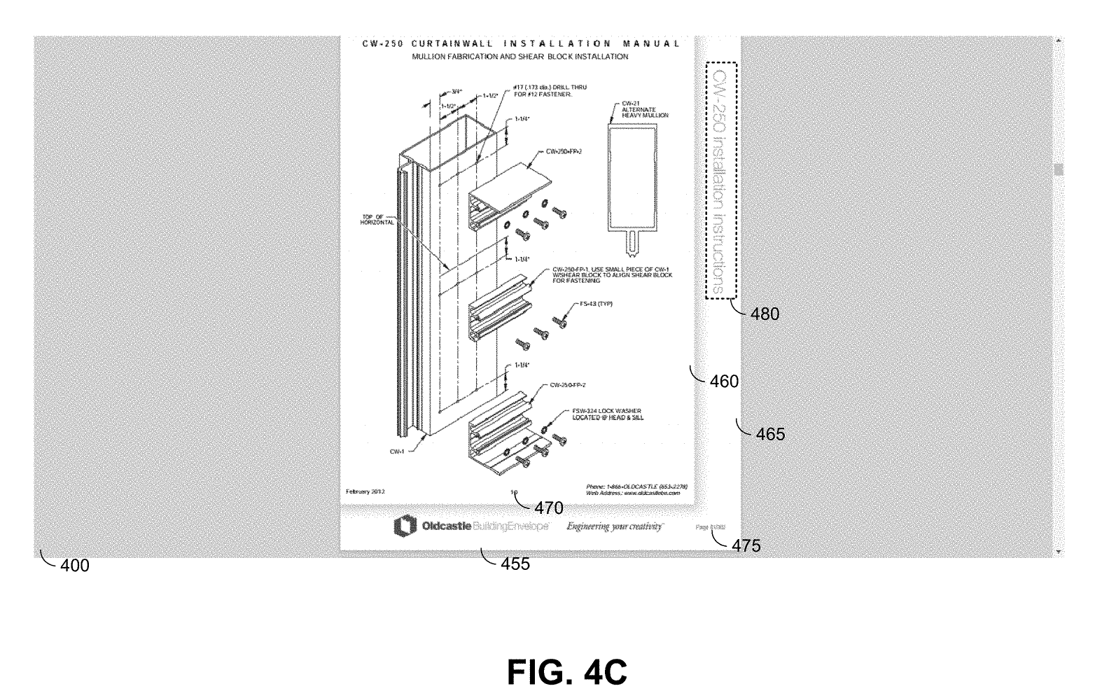

FIGS. 4A-4C are screen captures of a document viewer application showing pages from the composite document (which is provided in an electrical format, such as Portable Document Format (PDF)). It will be understood, however, that alternative embodiments may provide the document in additional and/or alternative formats to the format shown in FIGS. 4A-4C. The composite document can be made viewable on the user device 110 and/or another device executing the document viewer application, web browser, or the like. (The screen captures illustrated in FIGS. 4A-4C were generated using a particular PDF viewer application. It will be understood that other document viewers may be used.)

FIG. 4A is a screen capture of a document viewer screen 400 showing the title page 410 and bookmarks 420 of the consolidated document, according to an embodiment. Depending on desired functionality, consolidated document format, and/or other factors, the bookmarks 420 may be automatically generated as part of the consolidated document and may reflect a hierarchical levels of the consolidated document (as determined by the finalized document list 345 shown in FIG. 3C).

The contents of the title page 410 can vary, depending on desired functionality. In some embodiments, for example, the consolidated document may include the personalized logo 430 of the user (e.g., the contractor providing the construction project bid). (This personalized logo 430 may be uploaded by the user in a previous screen of the graphical user interface, for example.) In some embodiments, the title page 410 may further include a title of the consolidated document 435 and/or branding of the graphical user interface used to create the consolidated document. Additionally or alternatively, the title page 410 may include branding 440 of the materials provider. Other embodiments may include additional or alternative features on the title page 410.

FIG. 4B is a screen capture of the document viewer screen 400 showing a table of contents page 450 of the consolidated document, according to an embodiment. As shown, although the consolidated document may include various district of documents, each with corresponding page numbers, the consolidated document may be generated in such a way that the page numbers are continual from the beginning to the end of the consolidated document, as shown. (It can be noted, however, that different page numbering may be used, depending on desired functionality.)

As can be seen, the table of contents page 450 may show the hierarchy of the various descriptive documents contained in the consolidated document. As indicated previously, the hierarchy of the descriptive documents in the consolidated document can reflect the hierarchy determined by the document list 345 in FIG. 3C.

FIG. 4C is a screen capture of the document viewer screen 400 showing a document page 455 of the consolidated document, according to an embodiment. Here, the document page 455 includes an inner page 460 and a page frame 465. The inner page 460 may reflect the a page of a descriptive document incorporated into the consolidated document. In some embodiments, the page of the descriptive document may be unaltered and therefore may have its own page number 470. The page frame 465 may be an added feature of the consolidated document (not in the individual descriptive document) and may include its own page number 475 (corresponding to the page numbers of the consolidated document, such as those shown in the table of contents page 450). In some embodiments, the page frame 465 can include the document name 480 (e.g., as edited by the user in the document list 345), branding, and/or other markings.

It will be appreciated that alternative embodiments may include additional and/or alternative features on the document page. In some embodiments, for example, the page frame 465 may have a different shape and/or may be situated at different locations relative to the inner page 460. Some embodiments may replace the page frame 465 with one or more alternative features to indicate page number 475 and/or other attributes of the consolidated document. In some embodiments, these attributes may be overlaid onto the inner page 460 and/or may replace features on the inner page 460.

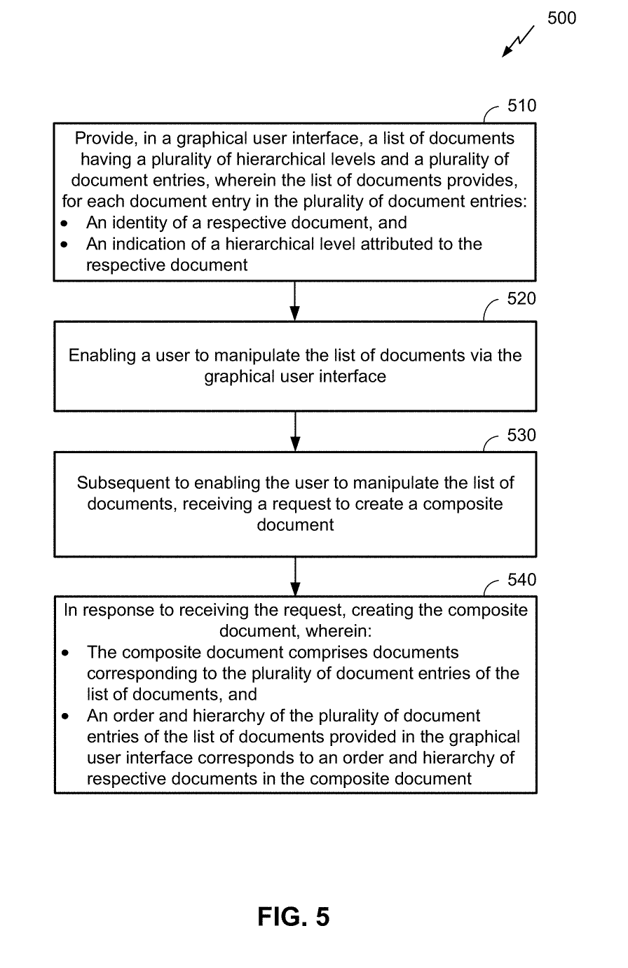

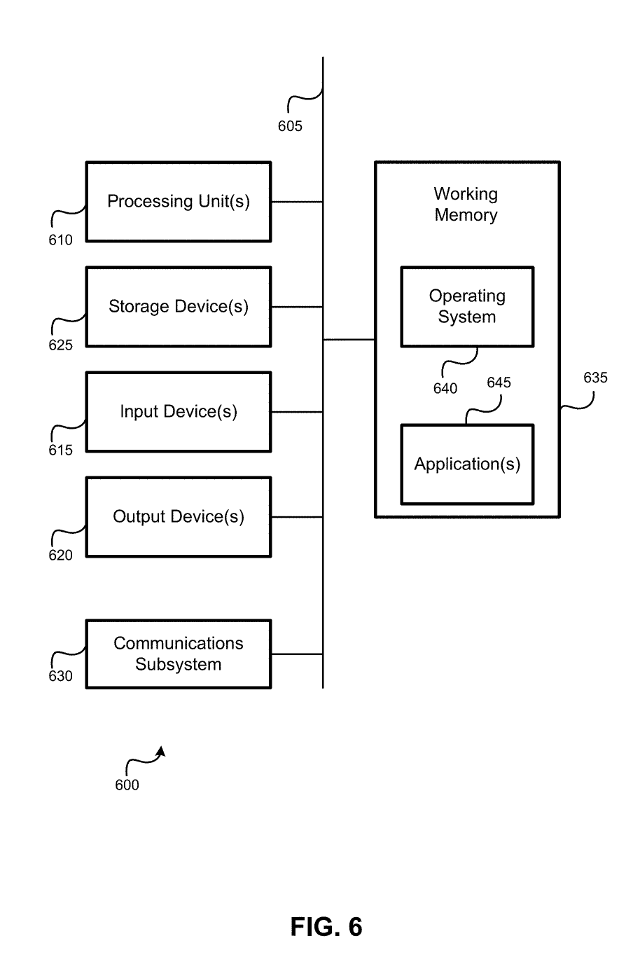

FIG. 5 is a flow diagram of a method 500 of enabling creation of documentation relating to a construction project, according to an embodiment. Any or all of the functions described in the various blocks illustrated in FIG. 5 can be performed by one or more components of a document creation system (e.g., document creation system 100 of FIG. 1; and in particular, server 120). Means for performing the functions can include software and/or hardware components of a computer system, such as the computer system 600 illustrated in FIG. 6 and described below.

The functionality at block 510 includes providing, in a graphical user interface, a list of documents having a plurality of hierarchical levels and a plurality of document entries. The list of documents provides, for each document entry in the plurality of document entries: that an identity of a respective document, and an indication of the hierarchical level attributed to the respective document. As indicated in the embodiments above, the list of documents may be shown in the graphical user interface as text and/or other graphical representations. In FIGS. 3A-3C, for example, each document entry in the document list 345 includes the title of the document in a rectangle representing the document entry. This rectangle may be nested within other rectangles to show the hierarchy of the respective document (e.g., the category, subcategory, etc. in which the respective document is included). Alternative embodiments may represent the document entries and the corresponding hierarchical levels in other ways, such as in a vertical or horizontal tree structure, using different graphical or textual indicators, etc. As indicated in the embodiments described above, the document list may be pre-populated based on information regarding the construction project obtained by, for example, the server 120. This may be obtained, for example, from the user via a previous screen or separate function of the graphical user interface. In other embodiments, this information may be obtained separately (such as by phone or email), and attributed to an account corresponding to the user (e.g., by the materials provider).

It as described in the embodiments above, the graphical user interface may be generated by a server (e.g., server 120 in FIG. 1) and accessed and displayed on a user device (e.g., user device 110). Other embodiments may use different devices to generate and/or display the graphical user interface. Means for performing the functionality at block 510 can include, for example, the communications subsystem 630, bus 605, working memory 635, operating system 640, application(s) 645, output device(s) 620, processing unit(s) 610, and/or other components of a computer system 600, as shown in FIG. 6 and described in more detail below.

At block 520, the functionality includes enabling the user to manipulate the list of documents via the graphical user interface. As previously explained, such manipulation can include adding document entries to the list, removing document entries from the list, changing the order and/or hierarchy of the document entries, changing document entry names, and the like. Changing the hierarchical level of a document may be in response to any of a variety of actions by any user. For example, the user may drag/drop the document entry under/into an existing category or subcategory, create a new category or subcategory that includes the document entry or into which the user inserts the documentary, remove or delete a category or sub category of which the document entry is a part, and the like. The user may alter the order of document entries in the document list in a similar manner, rearranging the order of the document entries as the user sees fit. In some embodiments, the graphical user interface may further enable the user to search for an additional document (e.g., from a document library stored by a database 130) and add an additional document entry, corresponding to the additional document, to the list of documents. In some embodiments, the graphical user interface may allow the user to upload a document to include in the composite document. (The document entry for the uploaded document may be included in the list of documents and manipulated by the user.)

Means for performing the functionality at block 520 can include, for example, the communications subsystem 630, bus 605, working memory 635, operating system 640, application(s) 645, output device(s) 620, processing unit(s) 610, and/or other components of a computer system 600, as shown in FIG. 6 and described in more detail below.

At block 530, the functionality includes, subsequent to enabling the user to manipulate the list of documents, receiving a request to create a composite document. The request to create the composite document may be made by the user, for example, by pressing a button or performing another triggering event on the graphical user interface.

Means for performing the functionality at block 530 can include, for example, the communications subsystem 630, bus 605, working memory 635, operating system 640, application(s) 645, output device(s) 620, processing unit(s) 610, and/or other components of a computer system 600, as shown in FIG. 6 and described in more detail below.

At block 540, the functionality includes, in response to receiving the request, creating the composite document. The composite document comprises documents corresponding to the plurality of document entries of the list of documents, and an order and hierarchy of the plurality of document entries of the list of documents provided in the graphical user interface corresponds to an order and hierarchy of their respective documents in the composite document. In other words, the user to manipulate the list of documents so that they appear in a corresponding fashion within the composite document. The order and hierarchy of the document in trees and the document list can result in a corresponding order and hierarchy of documents in the composite document.

As reflected in the embodiments described herein, the composite document may include both of the original content of the documents contained therein, and additional content. The additional content can include a title page and/or a table of contents. Furthermore, the composite document may include at least one page having an original page of a descriptive document, along with additional content. As shown in FIG. 4C, for example, an inner page 460 may include the original page of the district of document, and a page frame 465, may include additional features, such as the page number 475, document name 480, branding, and/or other features.

Means for performing the functionality at block 540 can include, for example, the communications subsystem 630, bus 605, working memory 635, operating system 640, application(s) 645, output device(s) 620, processing unit(s) 610, and/or other components of a computer system 600, as shown in FIG. 6 and described in more detail below.

FIG. 6 illustrates an embodiment of a computer system 600, which may be used, in whole or in part, to provide one or more functions of the embodiments described herein. Computer systems such as the computer system 600 illustrated in FIG. 6 may be used to implement components of the document creation system, such as a user device 110, server 120, and/or database 130 of the document creation system 100 illustrated in FIG. 1. Furthermore, hardware in slash or software components of the computer system 600 may be used to implement one or more features of the method 500 illustrated in FIG. 5.

It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different geographical locations.

The computer system 600 is shown comprising hardware elements that can be electrically coupled via a bus 605 (or may otherwise be in communication, as appropriate). The hardware elements may include processing unit(s) 610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 600 also may comprise one or more input devices 615, which may comprise without limitation a mouse, touchscreen, keyboard, camera, keypad, microphone, button, switch, and/or the like; and one or more output devices 620, which may comprise without limitation a display device, printer, speaker, and/or the like.

The computer system 600 may further include (and/or be in communication with) one or more non-transitory storage devices 625, which can comprise, without limitation, local and/or network accessible storage, and/or may comprise, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 600 might also include a communications subsystem 630, which may comprise wireless communication technologies (e.g., radio frequency (RF), infrared, etc.) and/or wired technologies (such as Ethernet, coaxial communications, universal serial bus (USB), and the like). As such, the communications subsystem 630 may comprise a modem, a network card (wireless or wired), an infrared communication device, a wireless communication device, and/or a chipset, and/or the like, which may enable the computer system 600 to communicate on any or all of the communication networks described herein to any device on the respective network, including the UE, other computer systems, and/or any other electronic devices described herein. Hence, the communications subsystem 630 may be used to receive and send data as described in the embodiments herein.

In many embodiments, the computer system 600 will further comprise a working memory 635, which may comprise a RAM or ROM device, as described above. Software elements, shown as being located within the working memory 635, may comprise an operating system 640, device drivers, executable libraries, and/or other code, such as one or more applications 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that may comprise memory may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method of enabling creation of documentation relating to a construction project, the method comprising:
providing, in a graphical user interface, a list of documents having a plurality of hierarchical levels and a plurality of document entries, wherein the list of documents provides, for each document entry in the plurality of document entries:
an identity of a respective document, and
an indication of a hierarchy attributed to the respective document;
enabling a user to manipulate the list of documents via the graphical user interface;
subsequent to enabling the user to manipulate the list of documents, receiving a request to create a composite document; and
in response to receiving the request, creating the composite document, wherein:
the composite document comprises documents corresponding to the plurality of document entries of the list of documents, and
an order and hierarchy of the plurality of document entries of the list of documents provided in the graphical user interface corresponds to an order and hierarchy of respective documents in the composite document.

2. The method of claim 1, further comprising providing the composite document to the user.

3. The method of claim 1, wherein enabling the user to manipulate the list of documents comprises enabling the user to, for at least one document entry of the plurality of document entries, alter the hierarchy attributed to the respective document.

4. The method of claim 1, wherein enabling the user to manipulate the list of documents comprises enabling the user to alter the order of the plurality of document entries of the list of documents, thereby altering the order of the respective documents in the composite document.

5. The method of claim 1, further comprising:
obtaining information regarding the construction project; and
initially populating the list of documents based on the obtained information regarding the construction project.

6. The method of claim 1, wherein creating the composite document comprises creating a table of contents of the composite document, the table of contents showing the hierarchy attributed to each document in the composite document.

7. The method of claim 1, further comprising enabling the user to, via the graphical user interface:
search for an additional document; and
add an additional document entry, corresponding to the additional document, to the list of documents.

8. The method of claim 7, wherein enabling the user to search for the additional document comprises accessing a database of available documents.

9. The method of claim 1, further comprising enabling the user to, via the graphical user interface, upload a document to include in the composite document.

10. The method of claim 1, wherein creating the composite document further comprises including, on at least one page of the composite document, an original page of a document in the composite document and at least one additional feature.

11. The method of claim 10, wherein the at least one additional feature comprises a page number of the composite document.

12. A server comprising:
a communication interface;
a memory; and
a processing unit communicatively coupled with the memory and the communication interface and configured to:
cause a graphical user interface to provide a list of documents having a plurality of hierarchical levels and a plurality of document entries, wherein the list of documents provides, for each document entry in the plurality of document entries:
an identity of a respective document, and
an indication of a hierarchy attributed to the respective document;
enable a user to manipulate the list of documents via the graphical user interface;
subsequent to enabling the user to manipulate the list of documents, receive a request to create a composite document; and
in response to receiving the request, create the composite document, wherein:
the composite document comprises documents corresponding to the plurality of document entries of the list of documents, and
an order and hierarchy of the plurality of document entries of the list of documents provided in the graphical user interface corresponds to an order and hierarchy of respective documents in the composite document.

13. The server of claim 12, wherein the processing unit is further configured to provide the composite document to the user via the communication interface.

14. The server of claim 12, wherein the processing unit is configured enable the user to manipulate the list of documents by enabling the user to, for at least one document entry of the plurality of document entries, alter the hierarchy attributed to the respective document.

15. The server of claim 12, wherein the processing unit is configured to enable the user to manipulate the list of documents by enabling the user to alter the order of the plurality of document entries of the list of documents, thereby altering the order of the respective documents in the composite document.

16. The server of claim 12, wherein the processing unit is further configured to:
obtain information regarding the construction project; and
initially populate the list of documents based on the obtained information regarding the construction project.

17. The server of claim 12, wherein the processing unit is further configured to enable the user to, via the graphical user interface:
search for an additional document; and
add an additional document entry, corresponding to the additional document, to the list of documents.

18. A non-transitory computer-readable medium having instructions embedded thereon for enabling creation of documentation relating to a construction project, the instructions including computer code for:
providing, in a graphical user interface, a list of documents having a plurality of hierarchical levels and a plurality of document entries, wherein the list of documents provides, for each document entry in the plurality of document entries:
an identity of a respective document, and
an indication of a hierarchy attributed to the respective document;
enabling a user to manipulate the list of documents via the graphical user interface;
subsequent to enabling the user to manipulate the list of documents, receiving a request to create a composite document; and
in response to receiving the request, creating the composite document, wherein:
the composite document comprises documents corresponding to the plurality of document entries of the list of documents, and
an order and hierarchy of the plurality of document entries of the list of documents provided in the graphical user interface corresponds to an order and hierarchy of respective documents in the composite document.

19. The non-transitory computer-readable medium of claim 18, wherein the instructions further include computer code for providing the composite document to the user.

20. The non-transitory computer-readable medium of claim 18, wherein the computer code for enabling the user to manipulate the list of documents comprises computer code for enabling the user to, for at least one document entry of the plurality of document entries, alter the hierarchy attributed to the respective document.
